(19) United States
(12) Patent Application Publication
(10) Pub. No.: US 2009/0045012 A1
(43) Pub. Date: Feb. 19, 2009

(54) Climbing foot and/or hand support

(76) Inventor: Gary S. Mencl, Lawton, MI (US)

Correspondence Address: HENNEMAN & ASSOCIATES, PLC, 714 W. MICHIGAN AVENUE, THREE RIVERS, MI, 49093, US

(21) Appl. No.: 11/893,472

(22) Filed: Aug. 16, 2007

(51) Int. Cl. E06C 7/00

(52) U.S. Cl. 182/92

(57) ABSTRACT

A novel climbing device for use in combination with a climbing spike, the climbing spike includes an anchor portion capable of being driven into a wooden object and a horizontal portion capable of being used as a step by a climber. The climbing device includes a body, a tread surface formed on a top portion of the body, a receiver fixed to the body and operative to receive the horizontal portion of the climbing spike, and a stabilizer fixed to the body and operative to limit relative movement between the body and the horizontal portion of the climbing spike. In a particular embodiment, the climbing device includes the climbing spike. In a more particular embodiment, the climbing device can be in either one of a first position or a second position. In the first position, the rotation of the body about the horizontal portion of the climbing spike is prevented. In the second position, the body is rotatable about the horizontal portion of the climbing spike. Further, the second position enables a user to anchor the climbing spike into a tree by gripping the body and rotating the climbing spike about the anchor portion.

### BACKGROUND OF THE INVENTION

1. Field of the Invention

This invention relates generally to climbing devices and methods and, more particularly, to methods and devices for climbing vertical wooden objects (e.g., trees, telephone poles, barn timbers, etc.). Even more particularly, this invention relates to climbing methods and devices that are useful in conjunction with climbing spikes.

2. Description of the Background Art

In many sports and/or occupations, it is necessary or desirable to climb wooden objects such as trees or wooden poles. For example, it is often advantageous for hunters to hunt from elevated positions in trees so as to remain undetected by the game. As another example, telephone repairmen sometimes climb utility poles to make repairs.

Many climbing devices are known. One commonly used device is a tree climbing apparatus as shown in U.S. Pat. No. 3,298,459 issued to Bergsten. Bergsten discloses a removable step member that is screwed into a tree. The device of Bergsten is essentially a Z-shaped member with a threaded screw at one end, a step portion at the other end, and an intermediate section that allows the user to crank the screw portion into a tree. Once fixed into the tree, the user can step up onto the step portion to climb the tree.

Although this type of tree climbing apparatus provides some benefits, it also has several disadvantages. One disadvantage is that the step portion typically includes a frictional surface (e.g., a scribed surface) which is hard on the user's hands when screwing the apparatus into the tree. Another disadvantage, is that the small surface area of the step portion (typically only a short piece of cylindrical rod) is difficult and/or dangerous to stand on. For example, a user could slip off of and be impaled by such tree climbing devices. Typically, hunting involves climbing into and out of trees when the sun is down, which adds to the danger. In addition, this type of climbing device is uncomfortable to stand on for prolonged periods of time.

What is needed, therefore, is a compact climbing device that is easy to mount to trees, poles, or the like. What is also needed is a device that provides a convenient means to climb in and out of trees or the like. What is also needed is a climbing device that easy and comfortable for a user to stand on and/or grasp. What is also needed is a safer climbing device.

### SUMMARY

The present invention overcomes the problems associated with the prior art by providing climbing devices and methods that improve comfort and safety when climbing. The invention additionally facilitates easier attachment and removal of climbing spikes from objects that are climbed.

One particular climbing device is useful in combination with conventional climbing spikes, which include an anchor portion capable of being driven (e.g., screwed) into a wooden object and a horizontal portion capable of being used as a step by a climber. The climbing device includes a body, a tread surface formed on a top portion of the body, a receiver fixed to the body to receive the horizontal portion of the climbing spike, and a stabilizer. The stabilizer is fixed to the body and limits relative movement between the body and the horizontal portion of the climbing spike.

In a particular embodiment, the stabilizer includes a channel disposed to accept portion of the climbing spike. For example, known climbing spikes include a vertical, intermediate portion extending between the anchor portion and the horizontal portion. The channel of the stabilizer extends vertically from a lateral edge of the body and is formed to accept the intermediate portion of the climbing spike. When the intermediate portion of the climbing spike is disposed in the channel, rotation of the climbing device around the horizontal portion of the climbing spike is prevented.

An optional locking mechanism locks the intermediate portion of the climbing spike into the channel of the stabilizer. In a particular example, the locking mechanism includes a pin receiving aperture formed in the stabilizer to accept a locking pin.

An example receiver of the climbing device includes an aperture and/or a channel formed to facilitate the passage of the horizontal portion of the climbing spike. The aperture is formed in a projection extending from a bottom surface of the body. In a particular embodiment, the aperture is oval to provide some play when inserting horizontal portion of the climbing spike into the aperture. The receiver also includes a channel formed to accept the horizontal portion of the climbing spike. The channel is formed in a second projection extending from the bottom surface of the body of the climbing device. Together, the aperture and the channel distribute weight applied to the climbing device along the horizontal portion of the climbing spike. In addition, the aperture prevents the climbing device from raising up off of the horizontal portion of the climbing spike.

The tread surface of the climbing device is formed to provide a safe, comfortable stepping surface. The tread surface includes a plurality of ridges for increased traction and a raised portion on a side opposite the stabilizer to prevent the users foot from sliding off of the climbing device. In addition, the tread surface includes one or more openings through the body of the climbing device, which makes the climbing device lighter and easier to grasp. In an example embodiment shown, the body, the tread surface, the receiver, and the stabilizer are all integrated in a unitary component (e.g., a single molded device).

In another embodiment, the climbing device includes and is permanently coupled to the climbing spike. The horizontal portion of the climbing spike is locked into the receiver by, for example, capping or flaring the free end of the horizontal section. The stabilizer is movable between a first position and a second position. In the first position, the stabilizer engages a portion (e.g., a vertical portion) of the climbing spike so rotation of the body about the horizontal portion of the climbing spike is prevented. In the second position, the body is freely rotatable about the horizontal portion of the climbing spike. The receiver is slidably coupled to the horizontal portion of the climbing spike such that sliding the receiver along the horizontal portion of the climbing spike moves the stabilizer between the first and second positions. A locking mechanism (e.g., a removable pin through the horizontal section of the climbing spike) locks the stabilizer in either the first or the second position.

Means for limiting relative movement between the body of the climbing device and the horizontal portion of the climbing spike are disclosed. Means for detachably mounting the climbing device to the climbing spike are also disclosed.

A method of climbing a wooden object is also described. The method includes the steps of providing a climbing spike including an anchor portion and a support portion, providing a tread, fixing the anchor portion of the climbing spike into the wooden object, and mounting the tread to the support portion of the climbing spike. In a particular method, the step of fixing the anchor portion of the climbing spike into the wooden object occurs before the step of mounting the tread to the support portion of the climbing spike. In another particular method, the step of mounting the tread to the support portion of the climbing spike includes rotatably mounting the tread to the support portion of the climbing spike, using the tread as a handle to drive (e.g., screw) the anchor portion of the climbing spike into the wooden object, and, after the anchor portion of the spike is driven into the wooden object, fixing the position of the tread with respect to the climbing spike. Optionally, the method further includes unfixing the position of the tread with respect to the climbing spike such that the tread is again rotatably mounted to the climbing spike, and using the step as a handle to remove the anchor portion of the climbing spike from the wooden object.

### BRIEF DESCRIPTION OF THE DRAWINGS

The present invention is described with reference to the following drawings, wherein like reference numbers denote substantially similar elements:

FIG. 1 is a top, rear perspective view of a climbing device of the present invention;

FIG. 2 is a side view of the climbing device of FIG. 1;

FIG. 3 is a bottom, front perspective view of the climbing device of FIG. 1;

FIG. 4 is an exploded view of the climbing device of FIG. 1;

FIG. 5 is a top, rear perspective view of another climbing device of the present invention;

FIG. 6 is a bottom, front perspective view of the climbing device of FIG. 5;

FIG. 7a is a side view of the climbing device of FIG. 5 with a stabilizer in an engaged position;

FIG. 7b is a side view of the climbing device of FIG. 5 with the stabilizer in a disengaged position; and

FIG. 8 is a flowchart summarizing an example method of using a climbing device.

### DETAILED DESCRIPTION

The present invention overcomes the problems associated with the prior art, by providing a step support for use in combination with a climbing spike. In the following description, numerous specific details are set forth (e.g., materials, fastening devices, climbing spike shape, etc.) in order to provide a thorough understanding of the invention. Those skilled in the art will recognize, however, that the invention may be practiced apart from these specific details. In other instances, details of well known manufacturing practices (e.g., molding, metal fabrication, etc.) have been omitted, so as not to unnecessarily obscure the present invention.

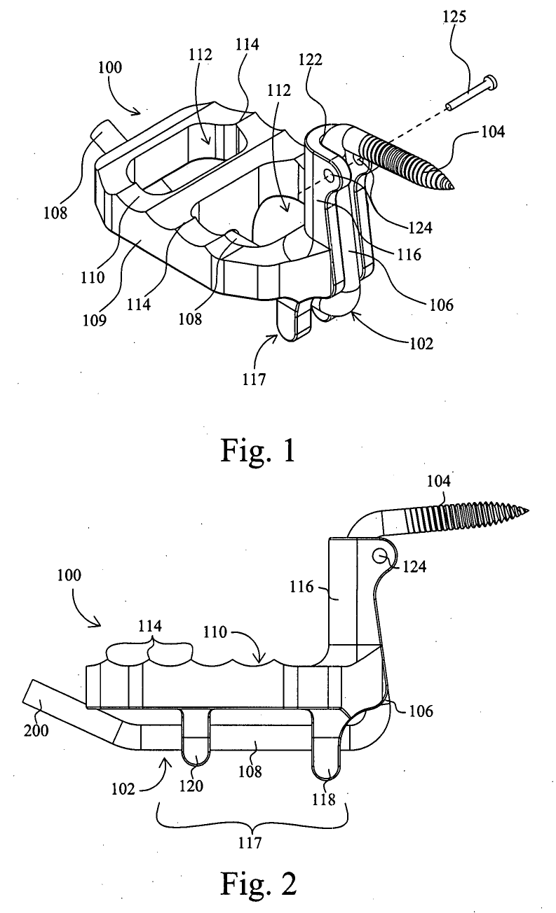

FIG. 1 shows a top, rear perspective view of a climbing device 100 coupled to a conventional climbing spike 102. In this particular embodiment, climbing spike 102 includes a threaded anchor portion 104, an intermediate portion 106, and a horizontal portion 108. Note that climbing spike structure and functions are disclosed in U.S. Pat. No. 3,298,459 issued to Bergsten, as discussed above.

Climbing device 100 includes a body 109 with a tread surface 110 formed on top to provide a user with a relatively large surface to stand upon or grasp while climbing. Body 109 defines two apertures 112 that make it easier for a user to grip while climbing. Tread surface 110 includes a plurality of ridges 114 that provide increased friction between a user's footwear and climbing device 100, so as to prevent slipping.

Climbing device 100 further includes a stabilizer 116 that extends vertically from the lateral edge of body 109. Stabilizer 116 includes a channel 122, a pair of apertures 124, and a retaining device 125 that function together to limit relative motion between climbing device 100 and climbing spike 102. In particular, channel 122 receives intermediate portion 106 of spike 102 so as to prevent climbing device 100 from rotating about horizontal portion 108. Apertures 124 receive retaining device 125 (e.g., a pin, clip, wire, etc.), which locks intermediate portion 106 of climbing spike 102 within channel 122, thereby limiting horizontal movement of climbing device 100 with respect to climbing spike 102.

Climbing device 100 also includes a receiver 117 that receives horizontal portion 108 such that climbing device 100 is seated on and supported by horizontal portion 108 of climbing spike 102. Receiver 117 also limits relative motion between climbing device 100 and climbing spike 102. In particular, receiver 117 prevents climbing device 100 from rotating about intermediate portion 106. In addition, the structure of receiver 117 (described in greater detail below) prevents climbing device 100 from raising up off of horizontal portion 108.

FIG. 2 is a side view of climbing device 100 coupled to climbing spike 102. Note that the end 200 of climbing spike 102 is slightly inclined. Body 109 extends horizontally a sufficient distance to engage inclined end 200, thereby providing additional support and further limiting any horizontal movement of climbing device 100 with respect to climbing spike 102.

Note that inclined end 200 of climbing spike 102 is not an essential element of the present invention. For example, climbing device 100 would also work in combination with a climbing spike having a completely straight horizontal portion. Retaining device 125 is sufficient to prevent climbing device 100 from moving along horizontal portion 108. Indeed, unless explicitly stated herein to the contrary, no single feature is considered to be an essential element of the present invention.

FIG. 2 also shows receiver 117 in greater detail to include a first portion 118 and a second portion 120. First portion 118 is formed on a first projection extending downwardly from body 109, and second portion 120 is formed on a second projection extending downwardly from body 109. Alternatively, receiver 117 could be formed as a single elongated structure on the bottom of body 117. As another example, receiver 117 could be formed as a bore through body 109.

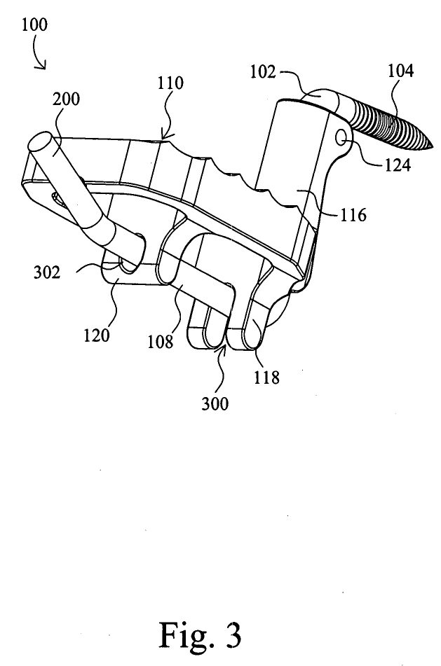

FIG. 3 is a bottom, front perspective view of climbing device 100 coupled to climbing spike 102. FIG. 3 shows that first portion 118 and second portion 120 of receiver 117 define a channel 300 and an aperture 302, respectively. Channel 300 receives horizontal portion 108 to help support and stabilize climbing device 100. Aperture 302 surrounds horizontal portion 108 so as to prevent climbing device 100 from moving in any direction that is perpendicular to horizontal portion 108. In other words, aperture 302 engages horizontal portion 108 to prevent climbing device 100 from lifting up off of climbing spike 102.

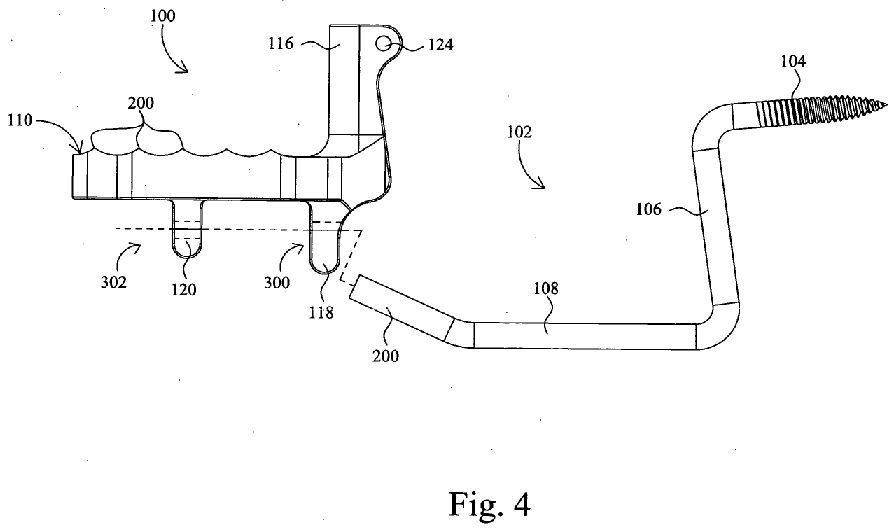

FIG. 4 is an exploded side view of climbing device 100 and climbing spike 102, illustrating that climbing device 100 is designed to be detachable from climbing spike 102. In addition, climbing device 100 can be easily reattached to climbing spike 102 or some other climbing spike. In this particular embodiment, climbing device 100 is coupled to climbing spike 102 by first seating horizontal portion 108 into channel 300, and then advancing climbing device 100 toward intermediate portion 106 so that horizontal portion 108 passes through aperture 302. Note that aperture 302 has an elliptical shape (see FIG. 3) to accommodate inclined end 200 of climbing spike 102. The elliptical shape of aperture 302 allows some tilting of climbing device 100 when horizontal portion 108 is disposed through aperture 302. Finally, retaining device 125 is inserted through apertures 124 so as to lock climbing device 100 onto climbing spike 102. In this manner, climbing device 100 can be fixed to climbing spike 102 either before or after climbing spike 102 is fixed to a tree.

Note that in this particular embodiment, the main elements of climbing device 100 are integrated in a single component. For example, climbing device 100 can be manufactured as a single plastic component via injection molding.

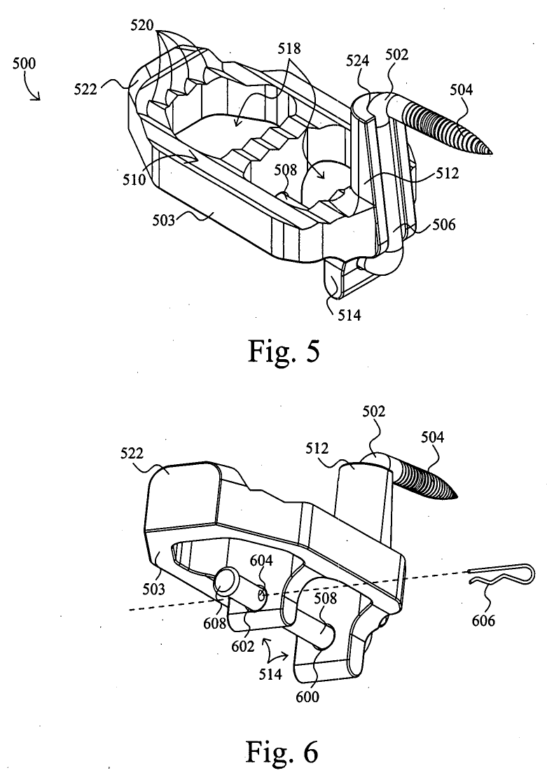

FIG. 5 shows a top, rear perspective view of an alternative climbing device 500 that includes an alternative climbing spike 502 and a tread 503. As will be apparent in the upcoming figures, tread is functional to facilitate the anchoring of climbing spike 502 into a wooden object (e.g., a tree, a pole, etc.). Alternative climbing spike 502 includes an anchor portion 504, an intermediate portion 506, and a horizontal portion 508. Anchor portion 504 includes threads that facilitate screwing anchor portion 504 into a tree. Intermediate portion 506 provides a lever arm for rotating anchor portion 504 and also serves to suspend horizontal portion 508 from anchor portion 504. Horizontal portion 508 provides support for tread 503 and, together with tread 503, serves as a handle for cranking anchor portion 504 into the tree. Thus, tread 503 functions as a step, a climbing grip, and a crank handle, all of which will be described in greater detail in the following figures.

Tread 503 includes a tread surface 510, a stabilizer 512, and a receiver 514 (only partially shown in FIG. 5). Tread surface 510 defines two apertures 518 and a plurality of ridges 520, which each function similarly to the analogous structures of climbing device 100 (FIGS. 1-4). In addition, tread 500 includes a flange 522. Flange 522 is relatively higher than tread surface 510 and blocks lateral sliding of a climbers foot.

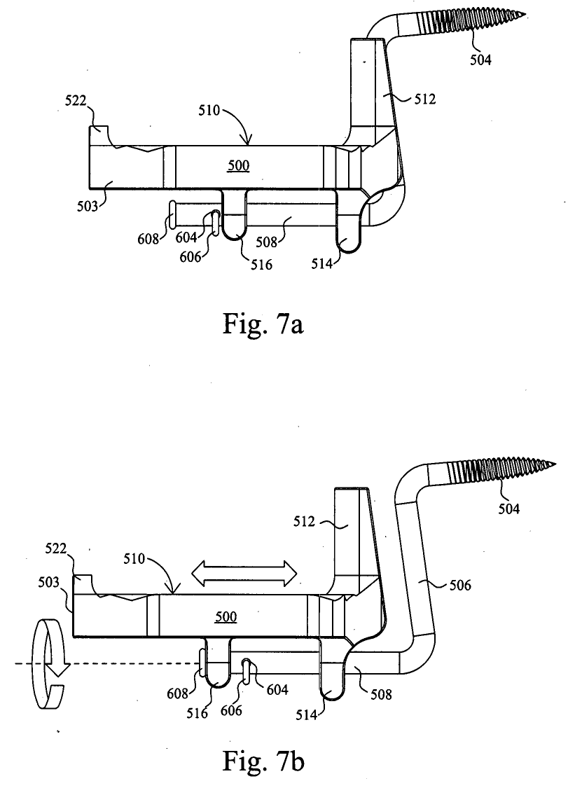

Stabilizer 512 is similar in structure and function to stabilizer 116, except that stabilizer 512 does not include apertures 124 or pin 125 to retain intermediate portion 506 in channel 524 of stabilizer 512. Instead, engagement between channel 524 and intermediate portion 506 is maintained by an alternate mechanism that will be described with reference to FIGS. 6-7b.

FIG. 6 shows a bottom, front perspective view of climbing device 500. In this particular embodiment, receiver 514 includes a first aperture 600 and a second aperture 602, each formed on a respective projection extending downwardly from the bottom of tread 503. Horizontal portion 508 is disposed through apertures 600 and 602 such that tread 500 can slide along horizontal portion 508 between a cranking position and a step position. A locking mechanism (e.g., a pin, a bolt, wire, etc.) is used to retain tread 503 in either of these positions. In this particular embodiment, the locking mechanism includes a hole 604 through horizontal portion 508 of climbing spike 502 and a removable pin 606 that blocks movement of tread 503 when inserted through hole 604. A retainer 608 prevents climbing device 500 from sliding completely off the end of horizontal portion 508. In this particular embodiment retainer 608 is formed by “mushrooming” the end of horizontal portion 508. Thus, tread 503 is not detachable from climbing spike 502. Alternatively, retainer 608 can be made from either a removable or nonremovable cap. The functionality of climbing device 500 when tread 503 is in the step position and the cranking position will described in greater detail with reference to FIG. 7a and FIG. 7b, respectively.

FIG. 7a is a side view of climbing device 500 with tread 503 in a first (step) position, wherein tread 503 is fixed with respect to climbing spike 502. In this first position, stabilizer 512, receiver 514, and retaining device 606 prevent relative movement between tread 503 and climbing spike 502. In particular, stabilizer 512 engages intermediate portion 506 so as to prevent tread 503 from rotating about horizontal portion 508. Similarly, receiver 514 prevents translational movement of tread 503 in any direction other than along horizontal portion 508 of climbing spike 502. Further, retaining device 606 prevents movement of tread 503 away from intermediate portion 506, which would cause stabilizer 512 to disengage intermediate portion 506. In this position, climbing device 500 can safely support a users step or grip when anchor portion 504 is anchored into a tree.

FIG. 7b is a side view of climbing device 500 with tread 503 in a second (cranking) position, wherein tread 503 is freely rotatable about horizontal portion 508 of climbing spike 502. Retaining device 606 is removed from hole 604 to allow tread 503 to slide into the cranking position and then reinserted to retain tread 503 in the cranking position. In this position, stabilizer 512 is disengaged from intermediate portion 506, so tread 503 is free to rotate about horizontal portion 508 similar to a bicycle pedal. This facilitates the use of tread 503 as a crank handle to screw anchor portion 504 of climbing spike 502 into (or out of) a tree by gripping tread 503 and rotating horizontal portion 508 about anchor portion 504 until climbing spike 502 is driven a sufficient depth into the tree. After climbing spike 502 is anchored, pin 604 is removed, tread 503 is slid back into the step position, and pin 604 is reinserted. With intermediate portion 506 being reseated within stabilizer 512, tread 503 can again be safely used as a step.

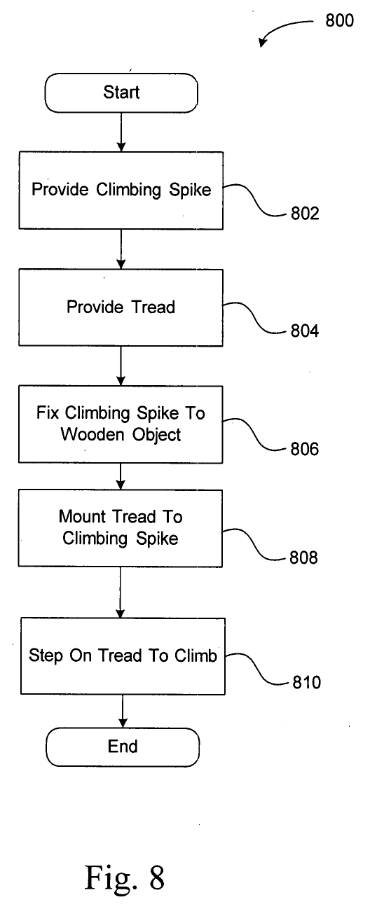

FIG. 8 is a flowchart summarizing one method 800 of using a tree climbing device according to the present invention. In a first step 802, a climbing spike is provided. Then, in a second step 804, a tread is provided. Next, in a third step 806, the climbing spike is fixed to a wooden object. Then, in a fourth step 808, the tread is mounted to the climbing spike. Next, in a fifth step 810, the tread is stepped upon to climb the wooden object.

Optionally, step 808 (mount tread to climbing spike) occurs prior to step 806 (fix climbing spike to wooden object). In that particular method, step 806 further includes using the tread as a crank handle to drive the climbing spike into the wooden object.

The description of particular embodiments of the present invention is now complete. Many of the described features may be substituted, altered or omitted without departing from the scope of the invention. For example, the aforementioned receiver and stabilizer designs could include either a channel, an aperture, or any combination thereof. Likewise, various retaining devices and retaining device receivers can be substituted for the retaining devices and retaining device receivers shown. For example, the cotter pin and aperture combination could be substituted by any device that limits relative movement between the climbing device and the climbing spike (e.g., screw, wire, alternative clips, etc.). It should also be noted that the climbing spike need not include a hole to receive a retaining device, but could instead include a notch or any other element that receives a removable limiting device. Indeed, it would be possible to use a retaining device such as a clamp that requires no complementary structure in the climbing spike. Further, the mushroomed end of the alternative spike could be any device that prevents the climbing device from sliding off of the climbing spike. For example, the climbing device could include a bead of metal that is applied after the alternative climbing device is coupled to the alternative climbing spike. Further, the mushroomed end could be replaced by a limiter that is removable (e.g., threaded end cap, pin receiving bore, etc.). It should also be noted that the stabilizer need not engage an intermediate portion of the climbing spike, but could instead engage the end of the climbing spike that curves upward. Alternatively, the stabilizer could include a shaped channel (e.g., hexagonal) that receives a similarly shaped horizontal portion of a climbing spike (e.g., hexagonal rod), thereby preventing rotation of the tread with respect to the climbing spike. This feature would allow the present invention to be used in combination with climbing spikes that are substantially straight and do not include an intermediate (e.g., vertical) portion. Examples of such climbing spikes include the L-shaped spikes commonly used on telephone poles. As even yet another example, the tread can be formed from a reflective or glow-in-the-dark material to increase the visibility of the climbing device in low-light situations. These and other modifications will be recognized by those skilled in the art in view of the present disclosure.

We claim:

1. A climbing device for use in combination with a climbing spike, said climbing spike including an anchor portion capable of being driven into a wooden object and a horizontal portion capable of being used as a step by a climber, said climbing device comprising:
a body;
a tread surface formed on a top portion of said body;
a receiver fixed to said body and operative to receive said horizontal portion of said climbing spike; and
a stabilizer fixed to said body and operative to limit relative movement between said body and said horizontal portion of said climbing spike.

2. A climbing device according to claim 1, wherein said stabilizer includes a channel disposed to accept an intermediate portion of said climbing spike, said intermediate portion of said climbing spike extending between said horizontal portion and said anchor portion.

3. A climbing device according to claim 2, wherein said channel of said stabilizer extends vertically from a lateral edge of said body.

4. A climbing device according to claim 2, wherein said stabilizer includes a locking mechanism for locking said intermediate portion of said climbing spike in said channel of said stabilizer.

5. A climbing device according to claim 4, wherein said locking mechanism includes a pin-receiving aperture.

6. A climbing device according to claim 1, wherein said receiver includes an aperture formed to facilitate the passage of said horizontal portion of said climbing spike.

7. A climbing device according to claim 6, wherein said aperture is formed in a projection extending from a bottom surface of said body.

8. A climbing device according to claim 6, wherein said aperture is non-circular.

9. A climbing device according to claim 6, wherein said receiver further includes a channel formed to accept said horizontal portion of said climbing spike.

10. A climbing device according to claim 9, wherein said channel is formed in a projection extending from a bottom surface of said body.

11. A climbing device according to claim 6, wherein
said aperture is formed in a first projection extending from a bottom surface of said body; and
said receiver further includes a channel formed to accept said horizontal portion of said climbing spike, said channel formed in a second projection extending from a bottom surface of said body.

12. A climbing device according to claim 1, wherein said receiver includes a channel formed to accept said horizontal portion of said climbing spike.

13. A climbing device according to claim 12, wherein said channel is fixed to a bottom portion of said body.

14. A climbing device according to claim 1, wherein said tread surface includes a plurality of ridges.

15. A climbing device according to claim 1, wherein said tread surface includes a raised portion on a side opposite said stabilizer.

16. A climbing device according to claim 1, wherein said body defines at least one opening from a top side of said body through a bottom side of said body.

17. A climbing device according to claim 1, wherein said body, said tread surface, said receiver, and said stabilizer are integrated in a unitary component.

18. A climbing device according to claim 1, further comprising said climbing spike.

19. A climbing device according to claim 18, wherein said receiver is coupled to said climbing spike.

20. A climbing device according to claim 18, wherein:
when said stabilizer is in a first position, rotation of said body about said horizontal portion of said climbing spike is prevented; and
when said stabilizer is in a second position, said body is rotatable about said horizontal portion of said climbing spike.

21. A climbing device according to claim 20, wherein said receiver is slidably coupled to said horizontal portion of said climbing spike such that sliding said receiver along said horizontal portion of said climbing spike moves said stabilizer between said first and said second positions.

22. A climbing device according to claim 21, wherein said stabilizer engages a vertical portion of said climbing spike when said stabilizer is in said first position.

23. A climbing device according to claim 20, further including a locking mechanism for locking said stabilizer in said first position or said second position.

24. A climbing device according to claim 23, wherein said locking mechanism includes a pin engaging a horizontal section of said climbing spike.

25. A climbing device for use in combination with a climbing spike, said climbing spike including an anchor portion capable of being driven into a wooden object and a horizontal portion capable of being used as a step by a climber, said climbing device comprising:
a body;
a tread surface formed on a top portion of said body;
a receiver fixed to said body and operative to receive said horizontal portion of said climbing spike; and
means for limiting relative movement between said body and said horizontal portion of said climbing spike.

26. A climbing device according to claim 25, further comprising means for detachably mounting said climbing device to said spike.

27. A method of climbing a wooden object, said method comprising:
providing a climbing spike including an anchor portion and a support portion;
providing a tread;
fixing said anchor portion of said climbing spike into said wooden object;
mounting said tread to said support portion of said climbing spike.

28. A method of climbing a wooden object according to claim 27, wherein said step of fixing said anchor portion of said climbing spike into said wooden object occurs before said step of mounting said tread to said support portion of said climbing spike.

29. A method according to claim 27, wherein said step of mounting said tread to said support portion of said climbing spike includes:
rotatably mounting said tread to said support portion of said climbing spike;
using said tread as a handle to drive said anchor portion of said climbing spike into said wooden object; and
after said anchor portion of said climbing spike is driven into said wooden object, fixing the position of said tread with respect to said climbing spike.

30. A method according to claim 29, further comprising:
unfixing the position of said tread with respect to said climbing spike such that tread is again rotatably mounted to said climbing spike; and
using said tread as a handle to remove said anchor portion of said climbing spike from said wooden object.
